(19) United States
(12) Patent Application Publication
(10) Pub. No.: US 2023/0335826 A1
(43) Pub. Date: Oct. 19, 2023

(54) ENERGY STORAGE SYSTEM

(71) Applicant: Carl Freudenberg KG, Weinheim (DE)

(72) Inventors: Peter Kritzer, Forst (DE); Richard Zuber, Gorxheimertal (DE); Tim Leichner, Moerstadt (DE); Daniela Woll, Bensheim (DE); Armin Striefler, Oehringen (DE); Dirk Moehring, Moerlenbach (DE); Grazyna Jedrowicz, Weinheim (DE); Stefan Morgenstern, Weinheim (DE); Maik Johe, Reichelsheim (DE); Joachim Heinemann, Weinheim (DE)

(21) Appl. No.: 18/074,535

(22) Filed: Dec. 5, 2022

(30) Foreign Application Priority Data
Dec. 6, 2021 (DE) 10 2021 132 072.0

(51) Int. Cl. H01M 10/653; H01M 50/209; H01M 50/293

(52) U.S. Cl. CPC H01M 10/653; H01M 50/209; H01M 50/293

(57) ABSTRACT

An energy storage system includes: a housing in which a plurality of battery cells are arranged. The battery cells are separated from each other by a device disposed between the battery cells. The device includes at least two layers. A first layer of the at least two layers forms a compression layer and a second layer of the at least two layers forms an insulating layer.

### CROSS-REFERENCE TO PRIOR APPLICATION

Priority is claimed to German Patent Application No. DE 10 2021 132 072.0, filed on Dec. 6, 2021, the entire disclosure of which is hereby incorporated by reference herein.

### FIELD

The invention relates to an energy storage system, comprising a housing in which a plurality of battery cells are arranged, wherein the battery cells are separated from each other by means of a device arranged between the battery cells, wherein the device includes at least two layers.

### BACKGROUND

Such an energy storage system is known from DE 10 2018 113 185 A1. Energy storage systems, in particular rechargeable batteries for electrical energy, are widely known especially in mobile systems. Rechargeable storage batteries for electrical energy are used, for example, in portable electronic devices, such as smartphones or laptop computers. Furthermore, rechargeable storage batteries for electrical energy are increasingly used for providing energy to electrically powered vehicles. A great variety of electrically powered vehicles is conceivable, such as bicycles, vans or trucks as well as cars. Applications in robots, ships, aircraft and mobile working machines are also conceivable. Further fields of use of electrical energy storage systems are stationary applications, such as in backup systems, in grid stabilization systems and for the storage of electrical energy from renewable energy sources.

A frequently used energy storage system is a rechargeable storage battery in the form of a lithium-ion battery. Lithium-ion batteries, just like other rechargeable storage batteries for electrical energy, mostly include a plurality of battery cells, which are installed in a common housing. Frequently, a plurality of joined battery cells are combined to a module.

The energy storage system does not only refer to lithium-ion batteries. Other rechargeable battery systems, such as lithium-sulfur batteries, solid-state batteries, sodium-ion batteries or metal-air electrochemical cells are conceivable energy storage systems. Furthermore, supercapacitors are also possible energy storage systems.

Energy storage systems in the form of rechargeable storage batteries have the highest electrical storage capacity and the best power intake or output only for a limited temperature spectrum. At temperatures above or below the optimum operating temperature range, the capacity, the power intake capacity and the power output capacity of the storage battery are substantially reduced and the functionality of the storage battery is negatively affected. Also, excessive temperatures can irreparably damage the storage battery. Continued exposure to high temperatures as well as short temperature peaks should be avoided at all cost. For lithium-ion batteries, for example, prolonged exposure to temperatures higher than 50° C. and short temperature peaks of more than 80° C. should not be exceeded.

In applications in cars, in particular, fast charging capability of the energy storage systems is desirable. The storage batteries forming an energy storage system are to be charged completely or almost completely within a short period of time, such as within 15 minutes. Due to the efficiency of the charging system of about 90% to 95%, large amounts of heat are emitted during the charging process, which have to be dissipated from the energy storage system. This amount of heat is not emitted in the normal mode of operation. It is therefore necessary to design the cooling system of the energy storage system in such a manner that the amount of heat arising during the charging process can be absorbed.

Excessive temperatures can lead to irreversible damage of the energy storage system. In this context, so-called thermal runaway is known, in particular, with lithium-ion cells. Herein, high thermal amounts of energy and gaseous decomposition products are released resulting in high pressures and high temperatures in the housing. This effect is problematic, in particular, in energy storage systems having high energy density, as is necessary, for example, to provide electrical energy in electrically powered vehicles. Due to increasing amounts of energy of the individual cells and the increase in the packing density of the cells arranged within the housing, the problem of thermal runaway is exacerbated.

In the vicinity of a runaway cell, temperatures in the range of 600° C. to 1000° C. can occur at the housing sidewall of the cell over a duration of several minutes. The device providing thermal insulation must be able to withstand such thermal loads and reduce energy transfer to adjacent cells in such a way that the thermal load on the adjacent cell is only at most 150° C. It is important to limit the energy transfer to the adjacent cells to prevent them from also thermally running away.

In particular in the field of electric mobility, there is a need to achieve high energy densities in a small space, which limits, however, the space available for the insulation of the cells. To prevent individual battery cells from being exposed to excessive thermal loads, it is also necessary to dissipate the heat released by the battery cell. For this purpose, it is in most cases not sufficient to just insulate the battery cells.

As viewed over their entire service life, lithium-ion storage batteries are subject to a volume change, wherein the volume increases with an increase in the service life. In the case of pouch cells this is noticeable as outward bulging. In addition, cyclic volume changes also occur with each charging or discharging process. The volume changes of the battery cells must be compensated by the device. This is either achieved by clamping the battery cells against each other which is accompanied by a very substantial increase in pressure. As an alternative, compression elements are arranged between the battery cells, which absorb volume changes of the battery cells.

The thermally insulating action of the known devices according to the state of the art is reduced as they are increasingly compressed. In most cases, the heat transfer is inversely proportional to the distance between the battery cells.

### SUMMARY

In an embodiment, the present invention provides an energy storage system, comprising: a housing in which a plurality of battery cells are arranged, wherein the battery cells are separated from each other by a device disposed between the battery cells, wherein the device includes at least two layers, and wherein a first layer of the at least two layers comprises a compression layer and a second layer of the at least two layers comprises an insulating layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows an energy storage system having a device;

FIG. 2 schematically shows the mechanical working range of the device;

FIG. 3 schematically shows a sectional view of a device according to a first embodiment;

FIG. 4 schematically shows a sectional view of a device according to a second embodiment;

FIG. 5 schematically shows a sectional view of a device according to a third embodiment;

FIG. 6 schematically shows a sectional view of a device according to a fourth embodiment;

FIG. 7 schematically shows a sectional view of a device according to a fifth embodiment;

FIG. 8 schematically shows the device of FIG. 6 at the top in a state without loading, at the bottom in a state mechanically loaded;

FIG. 9 schematically shows the device according to a sixth embodiment at the top in a state without loading, at the bottom in a state mechanically loaded;

FIG. 10 schematically shows the device according to a seventh embodiment at the top in a state without loading, at the bottom in a state mechanically loaded;

FIG. 11 schematically shows the device of FIG. 6 at the top in a state without loading, at the bottom in a state mechanically loaded;

FIG. 12 schematically shows the device of FIG. 9 with an additional layer;

FIG. 13 schematically shows the device of FIG. 12 in a further embodiment;

FIG. 14 schematically shows the device of FIG. 10 with an additional layer;

FIG. 15 schematically shows the device of FIG. 9 with an insulating layer on either side, wherein the insulating layer surrounds the compression layer on all sides;

FIG. 16 schematically shows the device of FIG. 9 with an insulating layer on either side, wherein the insulating layer covers the compression layer along the main sides;

FIG. 17 schematically shows a device with a frame element according to a first embodiment;

FIG. 18 schematically shows a device with a frame element according to a second embodiment;

FIG. 19 schematically shows a device with a frame element according to a third embodiment;

FIG. 20 schematically shows a device of FIG. 17, 18 or 19, wherein the frame element surrounds the device along the edges on all sides;

FIG. 21 schematically shows a device of FIG. 17, 18 or 19, wherein the frame element covers the device along two edges opposite each other;

FIG. 22 schematically shows a device of FIG. 3 with an additional edge element;

FIG. 23 schematically shows a device of FIG. 17 with an additional edge element;

FIG. 24 schematically shows a device of FIG. 16 with an additional edge element;

FIG. 25 schematically shows a device of FIG. 6 with an additional covering layer, which is flush with the insulating layer;

FIG. 26 schematically shows a device of FIG. 6 with an additional adhesive layer;

and

FIG. 27 schematically shows a device of FIG. 6 with two additional adhesive layers.

### DETAILED DESCRIPTION

In an embodiment, the present invention provides an energy storage system, which ensures long service life and high operating safety while providing high energy density.

The energy storage system according to the present invention comprises a housing in which a plurality of battery cells are arranged, wherein the battery cells are separated from each other by means of a device arranged between the battery cells, wherein the device includes at least two layers, wherein a first layer forms a compression layer and a second layer forms an insulating layer. Herein, the second layer is preferably formed to be incompressible.

With this embodiment, the insulating layer is optimized with respect to thermal insulation while the compression layer is optimized with respect to mechanical properties. The thermal insulation can be improved by an incompressible design of the insulating layer.

A plurality of first layers and/or a plurality of second layers may be provided. The overall thickness of the device is preferably between 0.5 mm and 6 mm. The overall thickness of between 0.5 mm and 6 mm is preferably still present even when the device has a surface pressure of up to 100 kPa applied to it. The compression layer and the insulating layer are preferably juxtaposed in the manner of a series connection.

It is conceivable for the device to comprise further layers in addition to the insulating layer and compression layer. In this context, it is conceivable to provide an application layer, a flame-retardant layer, a particulate retention layer and/or a heat sink layer. Overall, a device is created which has optimized mechanical properties so that high energy density and compact arrangement of the battery cells are possible while the insulating layer is thermally optimized and causes insulation of adjacent battery cells.

The insulating layer can have additional endothermal properties. The insulation preferably has endothermal properties in a temperature range between 150° C. and 500° C. In this embodiment, the compression element can absorb energy emitted by the battery cells thus preventing inadmissibly high increases in temperature in or on the battery cells. It is also conceivable for the compression layer to be thermally conductively equipped. For example, it is conceivable to provide metal hydroxides or metal carbonates.

The compression layer can have endothermal properties. By forming the compression layer in an endothermal and/or heat conductive manner, the insulating layer can be designed to be highly thermally insulating. Thus, the insulating layer can prevent inadmissibly high heat transfer between neighboring battery cells. Temperature peaks, which can occur, for example, during fast charging processes, can on the other hand, be dissipated by the compression layer due to the endothermal or heat-conductive equipment. The compression layer can include materials having an endothermal behavior, such as metal hydroxides or metal carbonates or citric acid. It is also conceivable for the compression layer to be equipped with fibers of materials having endothermal behavior.

Preferably, the compression layer has a thermal conductivity coefficient of up to 1.5 W/(m·K). The insulating layer preferably has a thermal conductivity coefficient of 0.2 W/(m·K), maximum.

The compression layer can be formed to be elastic. This enables the battery cells to be specifically compressed on the one hand. On the other hand, the compression layer can absorb volume changes of the battery cells. To do this, it is conceivable for the compression layer to be formed to be deformable. This can be achieved, for example, by shaping the compression layer. The material of the compression layer can also be deformable, or the compression layer can include deformable materials. Deformable materials are, for example, materials having intrinsic porosity.

Preferably, the compression layer is mechanically deformable. Particularly preferably, it is deformable by at least 50% at a surface pressure of between 30 kPa and 1,500 kPa. This means that the thickness of the compression layer is reduced as the surface pressure is increased, and can be reduced to at least 50% of the initial thickness.

Preferably, the insulating layer is mechanically less deformable than the compression layer. Particularly preferably for the insulation layer, at a surface pressure of between 30 kPa and 1,500 kPa, is a deformability of at most 30%. This means that the thickness of the insulation layer can be reduced as the surface pressure is increased. The insulation layer is preferably reducible only to at most 70% of the initial thickness. This enables the insulating layer to still provide good thermal insulating properties even when the device is strongly compressed.

During mechanical loading, the compression of the compression layer is preferably at least double the compression of the insulating layer.

The compression layer can be of an elastic material. In particular, it is conceivable for the compression layer to be of an elastomeric material.

The compression layer can be structured on a side facing the battery cell. The structuring on the one hand improves the deformability properties of the compression layer and on the other hand also has a thermal effect. Depending on the design of the structuring, channels may be created between battery cell and compression layer, via which the heat emitted by the battery cells can be dissipated. It is also conceivable, however, for the structuring to provide thermal insulation. It is thus conceivable to form fluid-conducting structures from the compression layer. The fluid-conducting structures also allow gases to escape from a battery cell in the case of a thermal runaway.

The compression layer can surround the insulating layer at least partially along the edges. In this embodiment, the compression layer reaches around the insulating layer at least in sections. Herein, the compression layer can be formed so that the insulating layer is embedded in the compression layer.

The insulating layer can be of a porous material. Porous materials are, for example, fibrous materials, such as non-woven fabrics, polymer-based foams or other foam-like solid materials. Furthermore, the porous materials can comprise zeolites, aerogels, pyrobubbles or gas-filled hollow spheres. It is also conceivable to use activated coal. The insulating layer can also be a fiber-based planar structure. Foam-based basic materials are also conceivable, in which the particulate insulating materials are embedded. Fillings of powdery insulating materials in predetermined regions are also conceivable in the compression layer.

A reinforcing layer can be arranged between the insulating layer and the compression layer. The reinforcing layer can be formed of a film or foil and can consist of plastic, metal or graphite.

The insulating layer can be formed in part of inorganic materials. Herein, the insulating layer is preferably incompressible, but elastically deformable. In particular, it is conceivable for the insulating layer to comprise fibrous materials. Preferably, the insulating layer is formed in such a manner that it has a porosity of at least 40% during the application of 1 MPa pressure on the device. The heat conductivity is to be at most 0.15 W/(m·K) even at maximum pressure application. The porosity of the insulating layer in the unloaded state is preferably at least 60%.

The content of inorganic materials in the insulating layer can be at least 60 weight percent. Inorganic materials to be used in the present case are, in particular, fibers, hollow spheres, aerogels, highly porous particles and/or the like.

The compression layer can be of polymeric materials, for example, elastomers, thermoplastic elastomers, thermoplastic or thermosetting plastics. The compression layer can be of metal and/or ceramic material.

The figures show an energy storage system 1 for storing electrical energy. In the present case, the energy storage system 1 comprises a housing 2, in which a plurality of battery cells 3 in the form of electrochemical storage batteries are arranged. The battery cells 3 of the present embodiment are formed as lithium-ion batteries. In an alternative embodiment, the battery cells 3 can be formed as solid-state batteries. The battery cells 3 are in the form of prismatic cells. In alternative embodiments, the battery cells 3 can also be pouch cells or cylindrical cells. The battery cells 3 are juxtaposed in the housing 2 and form a stack.

The battery cells 3 are thermally separated from one another and mechanically supported by means of a device 4 arranged between the cells 3. Herein, the device 4 comprises at least two layers 5, 6, wherein a layer 5 forms a compression layer and a layer 6 forms an insulating layer.

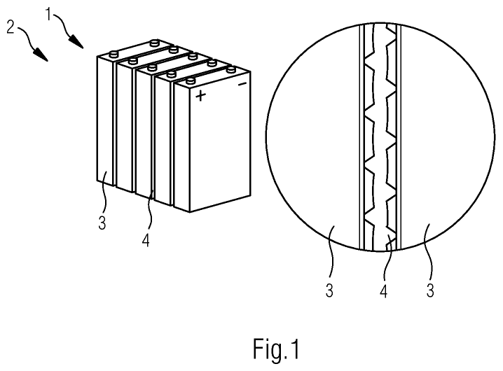

FIG. 1 shows a first embodiment of the above-described energy storage system 1. The device 4 disposed between the battery cells 3 comprises a second layer 6, which is incompressible and which forms an insulating layer, and first layers 5, which are compressible and which form compression layers, are disposed on either side of the second layer 6.

The compression layers 5 have elevations and depressions. Furthermore, the compression layers 5 are formed of an elastomeric material. By structuring the compression layers 5 and by using the elastomeric material, the compression layers are designed to be very deformable. The compression layers 5 are also designed to absorb and dissipate heat emitted by the battery cells 3. The insulating layer 6, on the other hand, causes thermal insulation of neighboring battery cells 3.

In the present embodiment, the heat conductivity of the insulating layer 6 is 0.1 W/(m·K). The device 4 has an endothermal heat intake of at least 300 kJ/kg. In the present embodiment, the thickness of the device 4 in the unloaded state is 4 mm and in the installed, clamped state, it is 3 mm.

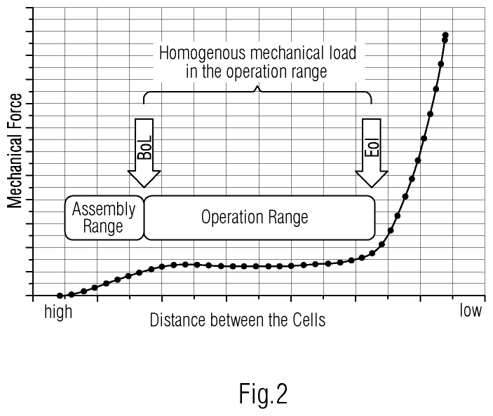

FIG. 2 shows the ideal mechanical operation range of a device 4. Herein, it can be seen that the swelling of the battery cells 3—which is the same as the reduction of the gap between the battery cells 3—does not cause a substantial increase of the mechanical forces in the operation range.

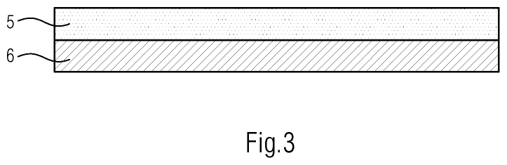

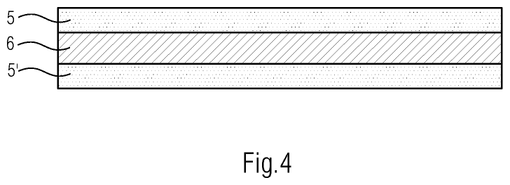

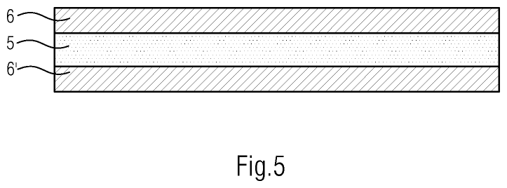

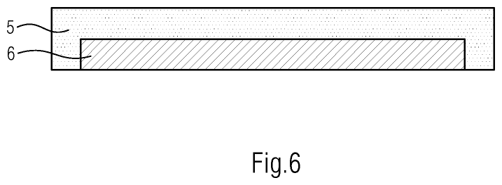

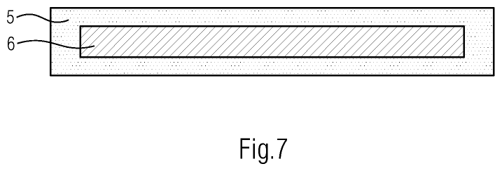

FIGS. 3 to 7 show in detail the device 4 of the energy storage system 1 shown in FIG. 1. In the present embodiment, the device 4 comprises two layers 5, 6, wherein a first layer 5 forms a compression layer and a second layer 6 forms an insulating layer. In the embodiment according to FIG. 3, the compression layer 5 and the insulating layer 6 are two continuous layers. In the embodiment according to FIG. 4, the insulating layer 6 is surrounded by compression layers 5 and 5′ on both sides. In the embodiment according to FIG. 5, the compression layer 5 is surrounded by insulating layers 6 and 6′ on both sides. In the embodiment according to FIG. 6, the compression layer surrounds the insulating layer 6 along two end faces. In the embodiment according to FIG. 7, the insulating layer 6 is embedded in the compression layer 5.

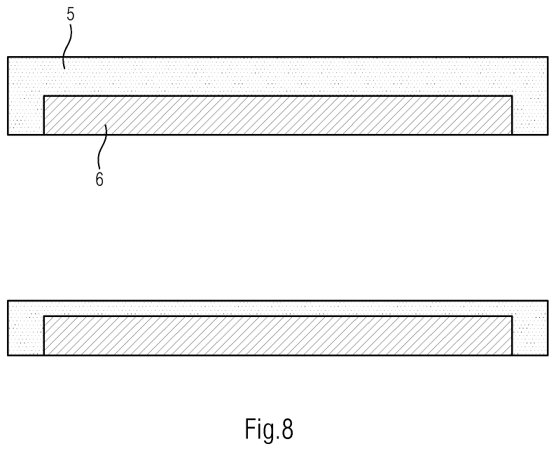

FIG. 8 shows the device 4 shown in FIG. 6, wherein the compression layer 5 of the device is deformed by a volume change of the battery cells 3. Herein, the compression layer 5 is primarily deformed. Due to its design, this layer 5 is only of secondary importance for thermal insulation. Its compression does not cause the thermal properties of the device 4 to deteriorate. However, the insulating layer 6 is not compressed, or only slightly compressed, during deformation. This results in the insulating layer 6 retaining its thermal insulating capability even in a compressed system. In the present exemplary embodiment, the compression layer 5 is of a silicone-based foam. The insulating layer 6 is of a nonwoven fabric of primarily inorganic fibers with a filling of inorganic insulating elements, in the present case of aerogels. In alternative embodiments, inorganic hollow spheres or porous inorganic particles can also be used.

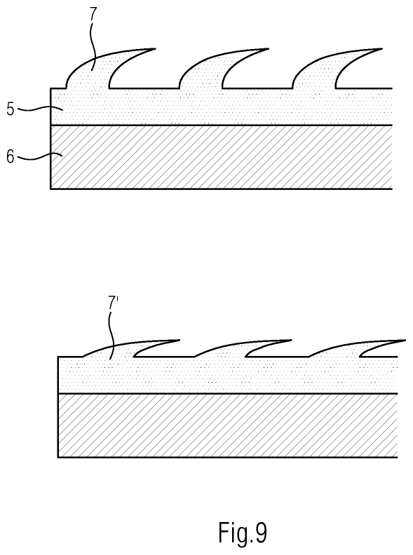

FIG. 9 shows the energy storage system 1 shown in FIG. 1, wherein the compression layer 5 of the device is deformed by a volume change of the battery cells 3. In the present case, the deformation is carried out by deformable structural elements 7 formed by the compression layer 5. In this embodiment, the compression layer 5 is of a mechanically rugged solid material, in the present case an elastomeric silicone. During mechanical loading, the deformable structural elements 7 are laid down flat to a compressed state 7′ so that the compression layer 5 can absorb the volume increase of the battery cells 3.

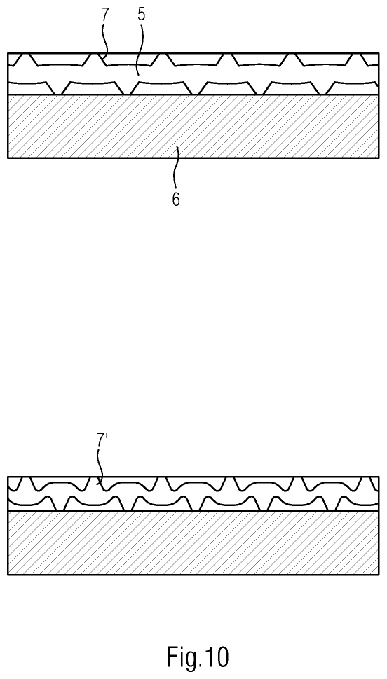

FIG. 10 shows a further embodiment of the device 4, wherein the compression layer 5 is deformed by a change in the volume of the battery cells 3. The deformation is carried out by deformable structural elements 7 of the compression layer 5. In the present case, the complete structure of the compression layer 5 is deformed.

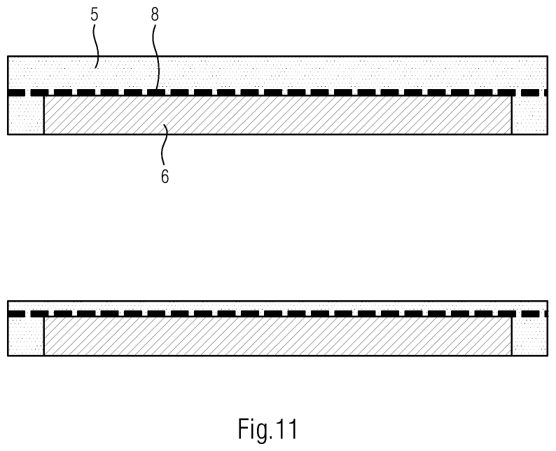

FIG. 11 shows the device 4 according to FIG. 6, wherein a reinforcing layer 8 is arranged between the compression layer 5 and the insulating layer 6. The reinforcing layer 8 is a solid layer and consists of an inorganic material. The inorganic material can be ceramic, graphite or metal or a thermosetting plastic. During deformation of the compression layer 5, the compressive force is spread over the surface area of the device 4. In addition, the reinforcing layer 8 spreads heat in the plane of the device 4.

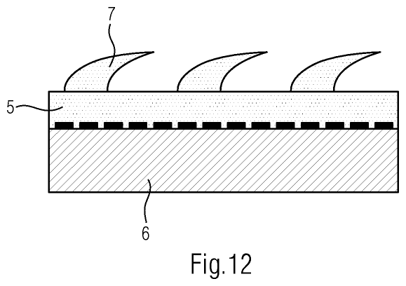

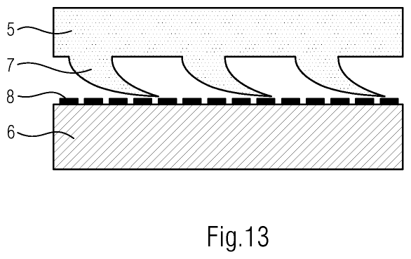

Each of FIGS. 12 and 13 shows a device 4 according to FIG. 9, wherein a reinforcing layer 8 is arranged between the compression layer 5 and the insulating layer 6. The reinforcing layer 8 is arranged between the compression layer 5 and the insulating layer 6. The reinforcing layer 8 spreads the inhomogeneities arising due to the deformation of the compression layer 5 caused by the deformable structural elements 7. The reinforcing layer 8 causes the pressure on the insulating layer 6 to be largely uniformly spread. This protects the insulating layer 6 against local pressure peaks. The deformable structural elements 7 can face away from the insulating layer 6 (FIG. 12) or face the insulating layer 6 (FIG. 13).

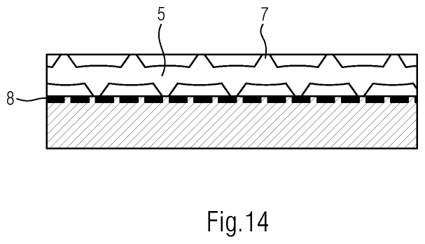

FIG. 14 shows a device according to FIG. 10, wherein a reinforcing layer 8 is arranged between the compression layer 5 and the insulating layer 6. The reinforcing layer 8 is a solid layer and consists of an inorganic material. The inorganic material can be ceramic, graphite or metal or a thermosetting plastic. During deformation of the compression layer 5, the compressive force is spread over the surface area of the device 4. In addition, the reinforcing layer 8 spreads heat in the plane of the device 4.

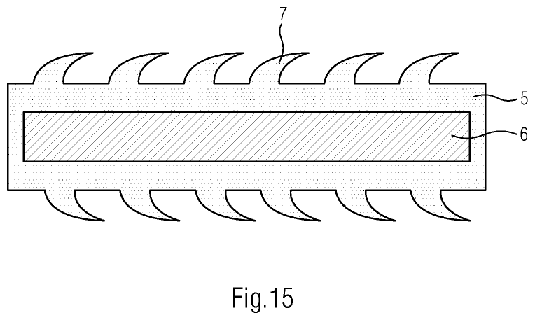

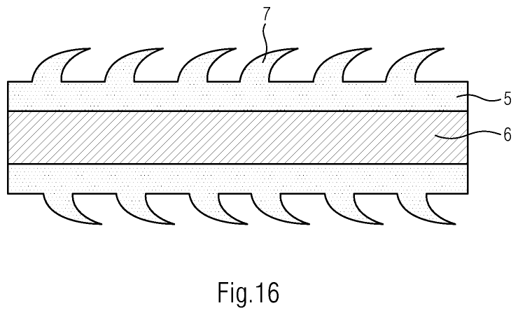

Each of FIGS. 15 and 16 shows a device according to FIG. 9, wherein two compressive layers 5 are provided which surround the insulating layer 6 across its surface. The compression layers 5 additionally surround the insulating layer 6 at two end faces (FIG. 15). This configuration allows the use of insulating layers 6 from which particles can be released depending on the structural preconditions. In the embodiment according to FIG. 16 two compression layers 5 cover the entire surface of the insulating layer 6. This embodiment is easily manufactured.

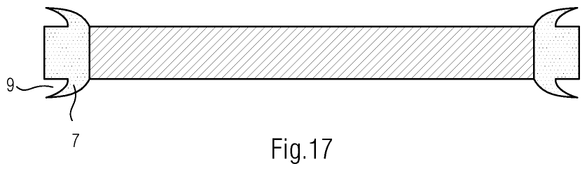

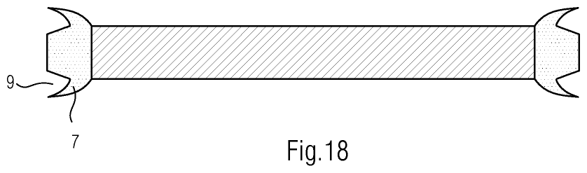

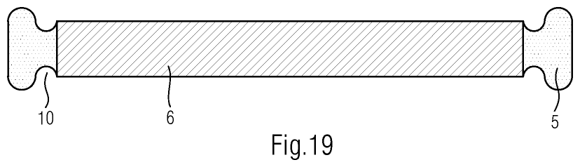

FIGS. 17 to 19 show devices 4 in which the insulating layer 6 is surrounded by the compression layer 5 only at the end faces, or in the manner of a frame. These embodiments allow the use of a small number of pressure-resistant insulating layers 6. Herein the compression layer 5 can include deformable structural elements 7. In the embodiment according to FIG. 17, the deformable structural elements 7 are made of an elastomeric silicone. In the completely deformed state, the thickness of the compression layer 5 forming a frame is still larger than the thickness of the insulating layer 6. In the embodiment according to FIG. 18, recesses 9 are provided, into which the deformable structural elements 7 can be displaced. The thickness of the compression layer 5 forming the frame, in the completely deformed state, is about as large as the height of the insulating layer 6. In the embodiment according to FIG. 19, further recesses 10 are provided into which a soft silicone material can be pressed, in particular. Again, the thickness of the frame of the compression layer 5 in the completely deformed state corresponds to the thickness of the insulating layer 6.

In all embodiments the deformability of the compression layer can be adapted to the mechanical properties of the insulating layer 6. Due to the comparatively small contact surface of the compression layer 5, relatively hard materials can be used, since the forces resulting on the compression layer 5 are high. On the other hand, particularly easily deformable insulating layers 6 can be used.

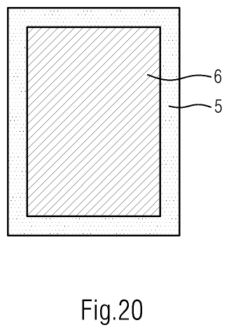

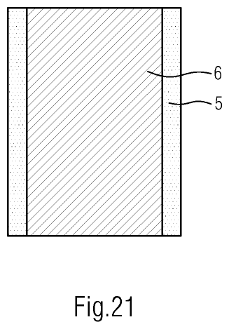

FIG. 20 shows embodiments of the device 4 shown in FIGS. 17 to 19, wherein the compression layer 5 surrounds the insulating layer 6 on all sides along the edges. FIG. 21 shows embodiments of the device 4 shown in FIGS. 17 to 19, wherein the compression layer 5 surrounds the insulating layer 6 along two edges opposite each other.

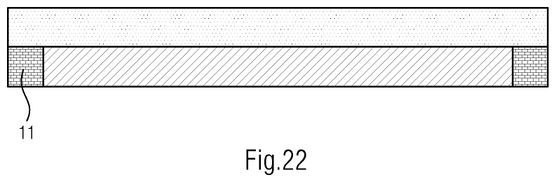

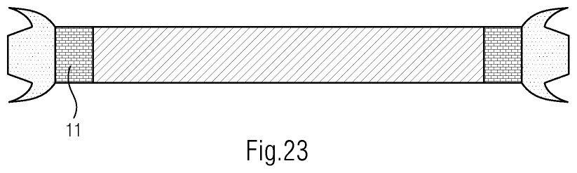

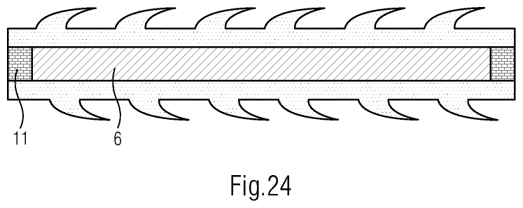

FIGS. 22 to 24 show a device 4 in which the insulating layer 6 is surrounded by a further frame element 11 along the end faces or along its circumference. The frame element 11 has about the thickness of the insulating layer 6. The frame element 11 can be of a harder material, for example a high-Shore elastomeric silicone. By these means, the insulating layer 6 is protected against deformation even under the application of strong mechanical forces.

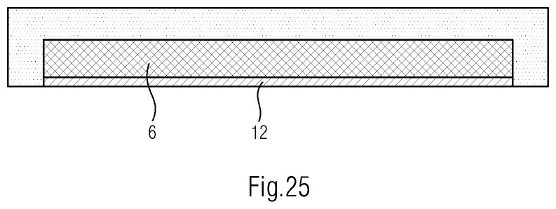

FIG. 25 shows a device 4 in which the insulating layer 6 is covered by a covering layer 12. The covering layer 12 ensures that particles are not released from the insulating layer 6 during installation and operation of the device 4. Due to the presence of such a covering layer 12, materials can also be used for the insulating layer 6 which contain little binder. The use of particle fillings, e. g. of aerogels, hollow spheres or ultra-porous fillers, is also conceivable.

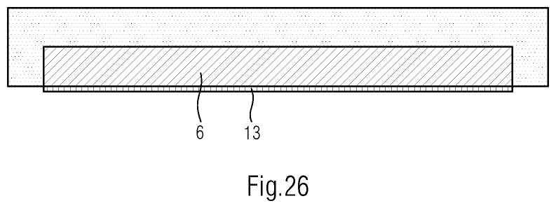

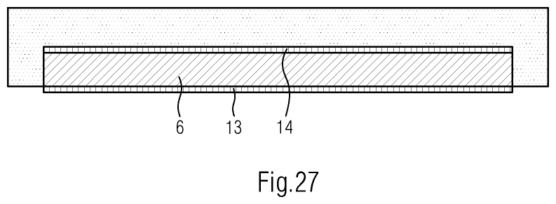

FIGS. 26 and 27 show further embodiments of the device 4. In the embodiment according to FIG. 26, an outer adhesive tape 13 is applied on the insulating layer, which both protects the insulating layer 6 and can be used in assembling the device 4 on the housing of the battery cell. In the embodiment according to FIG. 27, the insulating layer 6 is additionally provided with an internal adhesive layer 14. The latter is for the upstream assembly of the compression layer 5 and the insulating layer 6. This allows two layers optimized in themselves to be produced, which can be combined, for example, in a laminating process.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage system, comprising:
a housing in which a plurality of battery cells are arranged,
wherein the battery cells are separated from each other by a device disposed between the battery cells,
wherein the device includes at least two layers,
wherein a first layer of the at least two layers comprises a compression layer and a second layer of the at least two layers comprises an insulating layer.

2. The energy storage system of claim 1, wherein the compression layer is elastic.

3. The energy storage system of claim 1, wherein the compression layer is deformable.

4. The energy storage system of claim 1, wherein the compression layer comprises an elastic material.

5. The energy storage system of claim 1, wherein the compression layer is structured at least on a side facing a battery cell.

6. The energy storage system of claim 1, wherein the compression layer surrounds the insulating layer along edges at least in sections.

7. The energy storage system of claim 6, wherein the compression layer contacts adjacent battery cells.

8. The energy storage system of claim 6, wherein the insulating layer is embedded in the compression layer.

9. The energy storage system of claim 1, wherein fluid-conducting structures are formed of the compression layer.

10. The energy storage system of claim 1, wherein the insulating layer is incompressible.

11. The energy storage system of claim 1, wherein the insulating layer comprises a porous material.

12. The energy storage system of claim 1, wherein the insulating layer at least partially comprises an inorganic material.

13. The energy storage system of claim 1, wherein the insulating layer comprises a fibrous material.

14. The energy storage system of claim 1, wherein the insulating layer comprises thermally insulating particles.

15. The energy storage system of claim 14, wherein the thermally insulating particles comprise hollow spheres, highly porous particles, and/or aerogels.

16. The energy storage system of claim 1, wherein a reinforcing layer is disposed between the compression layer and the insulating layer.
